(19) United States
(12) Patent Application Publication
(10) Pub. No.: US 2005/0210495 A1
(43) Pub. Date: Sep. 22, 2005

(54) Tray-carrying disk device

(76) Inventor: Kazuhiro Watanabe, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/082,759

(22) Filed: Mar. 18, 2005

(30) Foreign Application Priority Data
Mar. 19, 2004 (JP) 2004-080229

(51) Int. Cl. G11B 23/03

(52) U.S. Cl. 720/725

(57) ABSTRACT

In order to move vertically a traverse unit in a tray-carrying disk device without using a laterally sliding movable rod, the traverse unit is provided at rear end portions thereof with the chassis pivotably supported by connecting members of an elastic material, and the substantially U-shaped traverse holder having arms extending from both ends thereof and pivotably connected to a front end portion of the chassis by connecting members of an elastic material, the arms being provided at front ends thereof with pivots for pivotably supporting the traverse unit, and at the base end portions thereof with outwardly projecting guide pins, the tray being provided on both side portions of a lower surface thereof with ribs having guide grooves in which the guide pins are loosely fitted, the guide grooves having differences in height, the traverse unit being moved up when the tray is moved back and housed in the device, to render the traverse unit possible to mount the disk on the tray on the turntable.

### BACKGROUND OF THE INVENTION

1. Field of the Invention

The present invention relates to a disk device utilizing a reciprocating slide for a tray as a means for vertically moving a traverse unit.

2. Related Art

In a disk device, the recording and reproducing of information are performed by setting a disk on a turntable and then rotating the turntable. There is a method using a tray as a representative means for transferring a disk onto a turntable. In this disk device, a disk is set on a tray, which is inserted into and withdrawn from an opening provided at a front side of the disk device, and transferred to the interior of the device. The disk is then rotated as the disk is held between the turntable and a clamper. Simultaneously with the rotation of the disk, an optical pickup is moved, and the reproduction of the recorded information is thereby carried out.

When the turntable is positioned in the center of the disk device, the disk being transferred to the interior of the device necessarily collides with the turntable. Therefore, the turntable, a spindle motor for rotating the turntable and an optical pickup unit for reading recorded signal information are provided on a traverse unit, and the traverse unit is formed in the following manner. The traverse unit is fixed so that the traverse unit can be turned at one end portion thereof as a fulcrum. When the disk transferred to the interior of the device reaches a predetermined position, the traverse unit is moved up pivotally to have the disk to be held between the turntable and clamper and fixed.

As such a tray type disk device, a “Disk Transfer Mechanism” disclosed in JP-A-9-106602 is known. It discloses a disk transfer mechanism for an optical disk device having a tray; a traverse unit provided with a signal reading portion, etc.; a unit for driving the tray and traverse unit separately and continuously; a first linkage means for withdrawing and inserting the tray from and into the device in accordance with an operation of the driving unit; a second linkage means for vertically moving the traverse unit; a first restriction means for restricting the position of the tray when the tray is housed in the device; and a second restriction means for restricting a vertical movement of the traverse unit, the second restriction means including a locking portion provided on a body, a locking claw provided in an opposed state with respect to the locking portion, and on a portion of the second linkage means so that the locking daw is integral with the second linkage means, a means for urging the locking claw, and a means for releasing the locking claw.

A projection provided at a front end of the traverse unit is loosely fitted in a cam groove of a laterally sliding movable rod, and, when the movable rod is slid laterally, the traverse unit is vertically moved with a base end portion thereof working as a fulcrum. Such a vertically movable mechanism for the traverse unit has been generally used, and the above-mentioned movable rod is needed for such a tray type disk device. However, driving unit for sliding the movable rod laterally becomes necessary, so that the construction of the disk device becomes complicated. Moreover, since the disk device accompanies a lateral movement, the width of a cabinet of the disk device becomes large. The driving means for the traverse unit of the disk device has the above-mentioned problems.

### SUMMARY OF THE INVENTION

To solve such problems, the present invention aims at providing a disk device capable of vertically moving a traverse unit without using a laterally sliding rod (slide cam).

Therefore, the disk device according to the present invention includes a tray providing with a rack meshed with a gear which is rotatable by a motor, and being capable of withdrawing and inserting a disk from and into an interior of a disk body, and a traverse unit vertically movable in accordance with movements of the tray, wherein the traverse unit including a chassis pivotably supported at a rear end portion thereof by connecting members of an elastic material, an optical pickup movably fixed on the chassis, and a substantially U-shaped traverse holder having arms extending from both ends thereof and pivotably connected to a front end portion of the chassis by connecting members of an elastic material, the arms being provided at front ends thereof with pivots supporting the traverse unit pivotably and at base end portions thereof with guide pins projecting outward, the tray being provided at both side portions of a lower surface thereof with ribs having guide grooves in which the guide pins are loosely fitted, the guide grooves being formed so as to have differences in height, whereby the traverse unit is moved up when the tray is moved back and housed in the interior of the device, to render the traverse unit possible to be mounted on a turntable.

In the disk device thus formed, the traverse unit thereof is supported pivotably on the pivots at the front ends of the arms on a body frame, and the rear end portion of the chassis is pivotably supported on connecting members of an elastic material so that the rear end portion of the chassis can be turned freely. The front-end portion of the chassis is pivotably connected to the traverse holder via the connecting member made of an elastic material. Therefore, the guide pins fitted loosely in the guide grooves, which have portions of different height, of the ribs slide in the guide grooves in accordance with a sliding movement of the tray. This enables the traverse unit to be turned around the pivots as fulcrums, and the front-end portions thereof to be vertically moved.

Each of these guide grooves can be made of a linear guide groove portion extending linearly in parallel with an upper surface of the tray, a locking guide groove portion formed in the vicinity of the upper surface of the tray, and an inclined guide groove portion communicating with the linear guide groove portion and locking guide groove portion.

According to the disk device of the present invention, the vertical movements of the traverse unit are made in accordance with the reciprocating sliding movements of the tray. Therefore, such a laterally sliding rod (slide cam) as is provided in a conventional disk device becomes unnecessary, and the manufacturing cost can be reduced owing to a decrease in the number of parts. Since the driving means for laterally sliding the movable rod also becomes unnecessary, the construction of the disk device is simplified, and time-consuming assembly job is also abbreviated. Especially, since the laterally sliding rod is not needed, the width of the cabinet can be reduced and disk device can be made more compact.

### BRIEF DESCRIPTION OF THE DRAWING

FIG. 1 is a perspective view of a tray-carrying disk device of an embodiment of the present invention;

FIG. 2 is a plan view showing the tray of the disk device;

FIG. 3 is a left side view showing the tray;

FIG. 4 is a perspective view showing a traverse unit of the disk device;

FIG. 5 is a side view showing the relation between the tray in a projecting state and traverse unit;

FIG. 6 is a side view showing the relation between the tray in a cabinet-housed state and traverse unit;

FIG. 7 is a side view showing the outline of the disk device with the tray projecting outside the cabinet; and

FIG. 8 is a side view showing the outline of the disk device with the tray housed in the cabinet.

### DETAILED DESCRIPTION OF PREFERRED EMBODIMENT

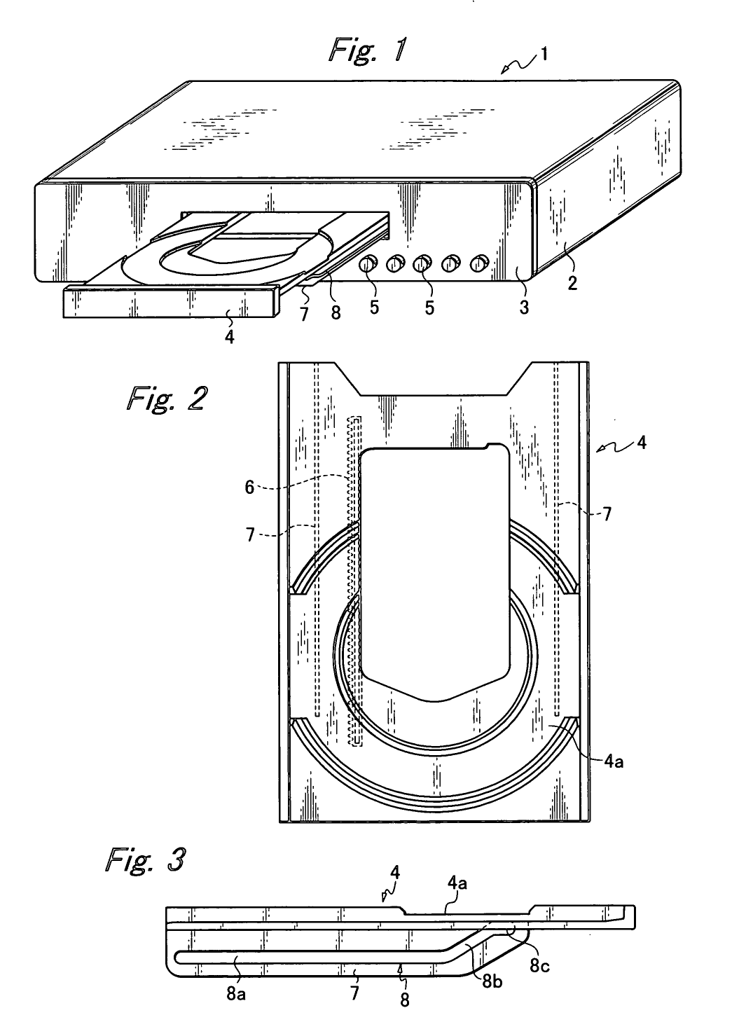

FIG. 1 shows an embodiment of a disk device according to the present invention, which includes a disk body 1, a cabinet 2, and a tray 4 capable of being withdrawn from and inserted into the disk body 1 through a withdrawal and insert port formed in a front panel 3 thereof. The tray 4 is adapted to carry out disk withdrawing and inserting operations by pushing a tray open/dose button out of a plurality of push-buttons 5, 5 . . . provided on the front panel 3.

As shown in FIGS. 2 and 3, the tray 4 is provided in an upper surface thereof with a circular recess 4a in which a disk is set, and on the side of a lower surface thereof with a rack 6 extending straight in the tray withdrawing and inserting direction. The tray 4 is provided at both side portions of the lower surface thereof with ribs 7, 7 extending in parallel with the tray withdrawing and inserting direction, and the ribs 7, 7 are provided with guide grooves 8 respectively. Each guide groove 8 includes a straight guide groove portion 8a formed on the lower side of the rib 7 and extending in parallel with the a recessed surface 4a of the tray, a locking guide groove portion 8c formed on the upper side of the rib 7, and an inclined guide groove portion 8b communicating with the straight guide groove portion 8a and the locking guide groove portion 8c.

In the tray 4 thus formed, a gear (not shown) rotated by a motor is meshed with the rack 6, and the tray slides by a distance determined by a rotation of the motor. As a result, the tray 4 is reciprocatingly moved between the disk exchange position and a disk reproduction position.

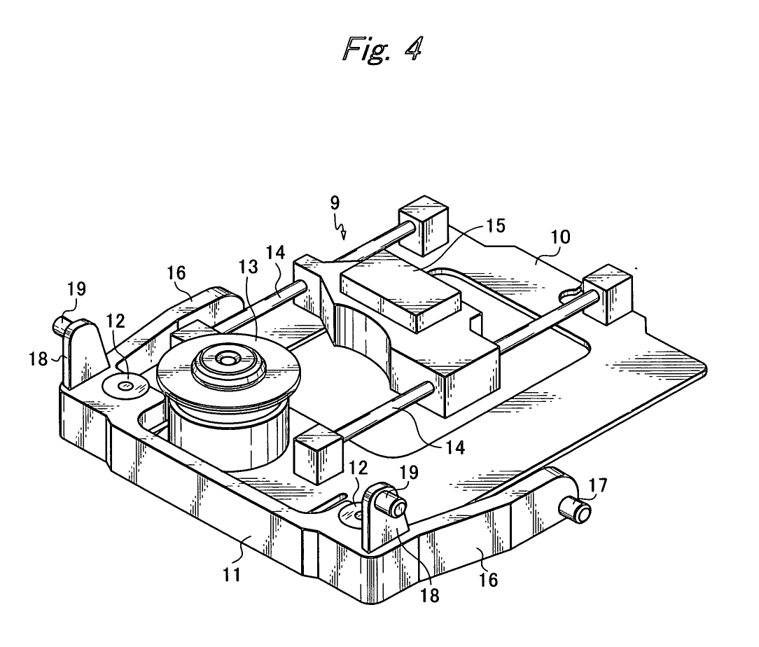

FIG. 4 shows traverse unit 9, which includes a chassis 10 made of a metal, and a substantially U-shaped traverse holder 11 made of a resin. The chassis 10 and traverse holder 11 are connected together by connecting members 12, 12 of rubber. On the chassis 10, a turntable 13 is fixed, and two guide rails 14, 14 are provided in parallel with each other. On these guide rails 14, 14, an optical pickup 15 is slidably mounted.

The pickup 15 is provided with a rack (not shown), with which a gear rotated by a motor is meshed. When the gear is rotated, the optical pickup 15 is moved along the two guide rails 14, 14. The traverse holder is provided at free ends of arms 16, 16 thereof with outwardly projecting pivots 17, 17, and at upper ends of guide pieces 18, 18 stood up on base portions of the same arms with guide pins 19, 19 projecting outward.

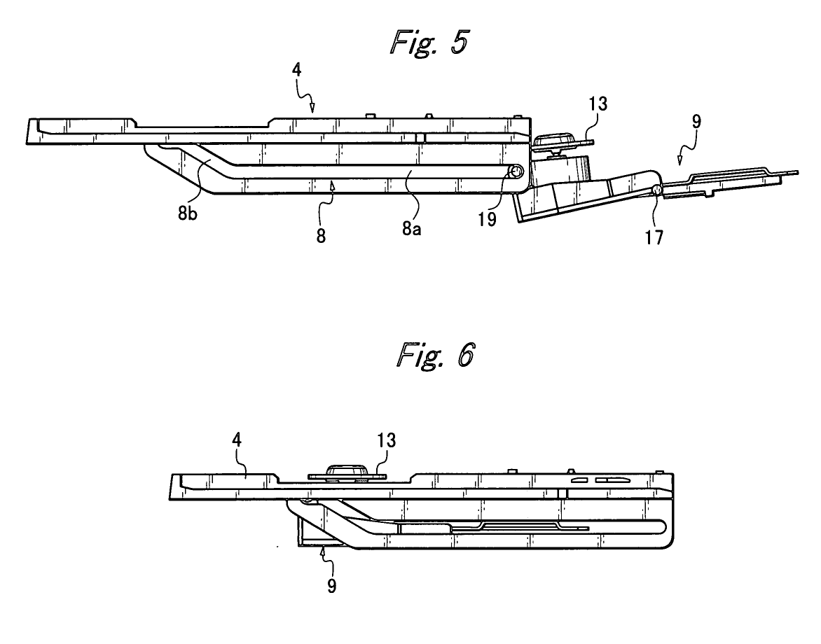

A rear end of the chassis 10 is connected to the cabinet 2 via connecting members (not shown) of rubber, and the pivots 17, 17 of the traverse holder 11 are fitted in bearings of a traverse retaining frame for holding the traverse unit 9. The guide pins 19, 19 are loosely fitted (FIGS. 5 and 6) in the guide grooves 8, 8 provided in the ribs 7, 7 of the tray 4. When the tray 4 slides, the guide pins 19, 19 are vertically moved along the guide grooves 8, 8, and the traverse unit 9 is vertically moved at a front side portion thereof (traverse holder-side portion) with the pivots 17, 17 working as fulcrums.

When the tray 4 projects outward in the disk exchange position, each guide pin 19 is in the straight guide groove portion 8a formed on the lower side of the rib 7, as shown in FIG. 5, and the traverse unit 9 is put in a front end lowered inclined state. When the tray 4 is moved back and housed in the interior of the cabinet 2, each of the guide pin 19 reaches the locking guide groove portion 8c (refer to FIG. 6), which is formed on the upper side of the rib 7, via the inclined guide groove 8b. Namely, a position in which the guide pin 19 reaches the locking guide groove portion 8c becomes the disk reproduction position.

In other words, when the guide pin 19 is in the straight guide groove portion 8a even though the tray 4 is slid backward, the traverse unit 9 is left in a lowered state, and the disk can slide backward (refer to FIG. 5) with the disk not contacting the turntable 13. When the tray 4 further slides backward to reach the inclined guide groove portion 8b, the guide pin 19 starts moving up, and the front portion of the traverse unit 9 also starts moving up. During this time, a central hole of the disk set in the circular recess 4a in the upper surface of the tray 4 comes close to the turntable 13. When the tray 4 is further moved back to cause the guide pin 19 to be loosely fitted in the locking guide groove portion 8c with the traverse unit 9 becoming horizontal (refer to FIG. 6), a central projecting portion of the turntable 13 is fitted in the central hole of the disk. As a result, the disk is mounted on the turntable 13.

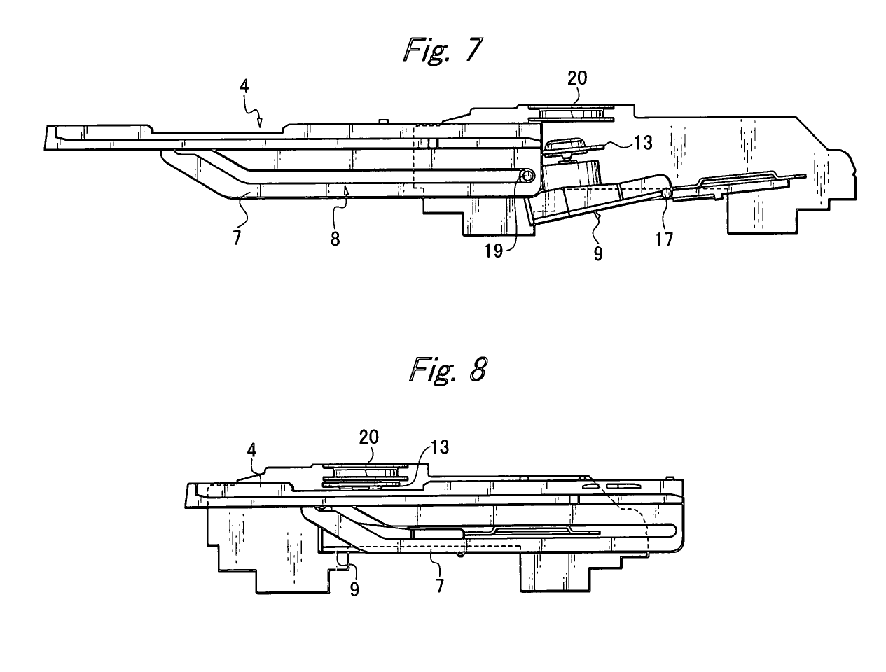

To be more precise, when the tray 4 projects from the disk device 1, the traverse unit 9 is in a lowered position as shown in FIG. 7, and a space is formed between a clamper 20 fixed to an upper portion of the device and turntable 13. The disk set on the tray 4 is inserted up to a disk reproduction position in the device through this space. In the reproduction position shown in FIG. 8, the disk mounted on the turntable 13 is held between the turntable 13 and clamper 20. Thus, the traverse unit 9 can be vertically moved in accordance with the reciprocating sliding movements of the tray 4, and such a laterally sliding rod as is provided in a conventional disk device of this kind is not needed.

1. A disk device comprising a tray providing with a rack meshed with a gear which is rotatable by a motor, and being capable of withdrawing and inserting a disk from and into an interior of a disk body, and a traverse unit vertically movable in accordance with movements of the tray,
wherein the traverse unit including a chassis pivotably supported at a rear end portion thereof by connecting members of an elastic material, an optical pickup movably fixed on the chassis, and a substantially U-shaped traverse holder having arms extending from both ends thereof and pivotably connected to a front end portion of the chassis by connecting members of an elastic material, the arms being provided at front ends thereof with pivots supporting the traverse unit pivotably and at base end portions thereof with guide pins projecting outward,
the tray being provided at both side portions of a lower surface thereof with ribs having guide grooves in which the guide pins are loosely fitted, the guide grooves being formed so as to have differences in height,
whereby the traverse unit is moved up when the tray is moved back and housed in the interior of the device, to render the traverse unit possible to be mounted on a turntable.

2. A disk device according to claim 1, wherein each guide groove includes straight guide groove portion extending straight in parallel with an upper surface of the tray, locking guide groove portion formed in the vicinity of the upper surface of the tray, and inclined guide groove portion communicating with the straight guide groove portion and locking guide groove portion.
